(19) United States
(12) Patent Application Publication
(10) Pub. No.: US 2013/0291647 A1
(43) Pub. Date: Nov. 7, 2013

(54) METHOD FOR DETERMINING FATIGUE STRENGTH OF ENGINE COMPONENTS

(71) Applicant: Fredrik Wilberfors, Grodinge (SE)

(72) Inventor: Fredrik Wilberfors, Grodinge (SE)

(21) Appl. No.: 13/979,776

(22) PCT Filed: Jan. 31, 2012
(86) PCT No.: PCT/SE2012/050090

§ 371 Date: Jul. 15, 2013

(30) Foreign Application Priority Data
Feb. 4, 2011 (SE) 1150078-2

(51) Int. Cl. G01N 3/08

(52) U.S. Cl. CPC G01N 3/08
USPC 73/826

(57) ABSTRACT

A method for determining fatigue strength of engine components, comprising the steps of -providing an engine component, -loading at least part of the component to a level below its tensile strength and measuring its resulting deformation, -determining at least one magnitude on the basis of the load applied and the deformation measured, -providing a predetermined relationship between measured fatigue strength of components and the aforesaid at least one magnitude determined on the basis of the ratio between load applied to engine components and their deformation, -determining the fatigue strength of the engine component provided,on the basis of the at least one magnitude determined and the predetermined relationship.

### TECHNICAL FIELD

The present invention relates to a method for determining fatigue strength of engine components according to the preamble of claim 1.

### BACKGROUND

Engine components such as engine blocks and cylinder heads are currently quality-assured by cyclic fatigue testing which subjects them to repeated loads until they disintegrate. This method, see for example U.S. Pat. No. 4,090,401, is time-consuming, which means that only a small proportion of components can be tested. It also destroys perfectly functional components.

In a further method for assuring the quality of engine components, tensile tests are carried out on test bars cast jointly with the engine components. The breaking stress of each test bar then serves as a basis for drawing conclusions about the fatigue strength of the respective engine component. However, comparative tests have shown that the match between the tensile strength of test bars and the fatigue strength of engine components is not entirely reliable.

An object of the present invention is therefore to propose a method by which the fatigue strength of engine components can be determined with greater reliability at high testing rates.

### SUMMARY OF THE INVENTION

According to the invention, this object is achieved by a method for determining the fatigue strength of engine components which is characterised by comprising the steps of
providing an engine component,
loading at least part of the component to a level below its tensile strength and measuring its resulting deformation,
determining at least one magnitude on the basis of the load applied and the deformation measured,
providing a predetermined relationship between measured fatigue strength of engine components and the aforesaid at least one magnitude determined on the basis of the ratio between load applied to them and their deformation,
determining the fatigue strength of the engine component provided on the basis of the at least one magnitude determined and the predetermined relationship.

The method achieves a generally very good match between estimated and actual fatigue strength of engine components.

As the magnitude used for determining the fatigue strength of an engine component is itself determined at low load, typically below the component's tensile strength or below the fatigue limit, there is no risk of the component being destroyed. This makes it possible to subject engine components which are to be used in actual operation to a rapid quality check at high testing rates. The estimation of their fatigue strength can be done with great accuracy as a result of being based on magnitudes which are measured on the actual component instead of on reference parts such as test bars made jointly with the respective component.

The engine component preferably takes the form of a cylinder head or an engine block for a heavy vehicle, preferably a truck.

According to an alternative, the whole component is loaded.

According to an alternative, the component is loaded to a level below its fatigue limit.

According to an embodiment, the component is loaded by a force applied to it by a force-transmitting means acting upon it.

With advantage, the force is applied to the component by moving the force-transmitting means relative to it, and the resulting deformation of the component is measured as the distance which the force-transmitting means has travelled.

According to an alternative, a test bar intended for tensile testing is cast jointly with, or is taken from, the component, and the test bar's tensile strength is determined and is itself used to determine the fatigue strength of the component provided.

### DEFINITIONS

“Fatigue strength” means herein the amount of cyclic loading to which a component can be subjected before a predetermined value representing the amount or length of cracks which form in it is exceeded.

“Fatigue limit” means herein the maximum stress to which a component or parts of it can be subjected an infinite number of times repetitively without cracks occurring in it.

The expression “strength parameters” means herein parameters derivable from a so-called tensile test curve representing the ratio between stress and strain in a test bar. Examples of strength parameters are maximum stress [Rm], stress at 0.1% total strain [Rₜ(0.1), stress at 0.2% total strain [Rₜ(0.2), stress at 0.4% total strain [Rₜ(0.4), stress at 0.1% plastic strain [Rₚ(0.1)], stress at 0.2% plastic strain [Rₚ(0.2)], the slope of the stress-strain curve at 0 MPa [E₀], the slope of the stress-strain curve at 20 MPa [E₂₀], the slope of the stress-strain curve at 50 MPa [E₅₀], the slope of the stress-strain curve at 100 MPa [E₅₀], the slope of the stress-strain curve at 150 MPa [E₁₅₀], and total elongation at maximum stress [A_{gt}].

### DESCRIPTION OF DRAWINGS

FIGS. 1a and 1b: Schematic tensile test patterns for steel and a grey iron.

FIG. 2: Diagram of relationship between fatigue strength of cylinder head and tensile strength of test bar.

FIG. 3: Diagram of relationship between fatigue strength of cylinder head and E₁₀₀ of test bar.

FIG. 4: Diagram of relationship between fatigue strength of cylinder head and tensile strength and E₁₀₀ of test bar.

FIG. 5: Schematic diagram of a device for deformation measurement according to an embodiment of the method according to the invention.

### DESCRIPTION OF THE INVENTION

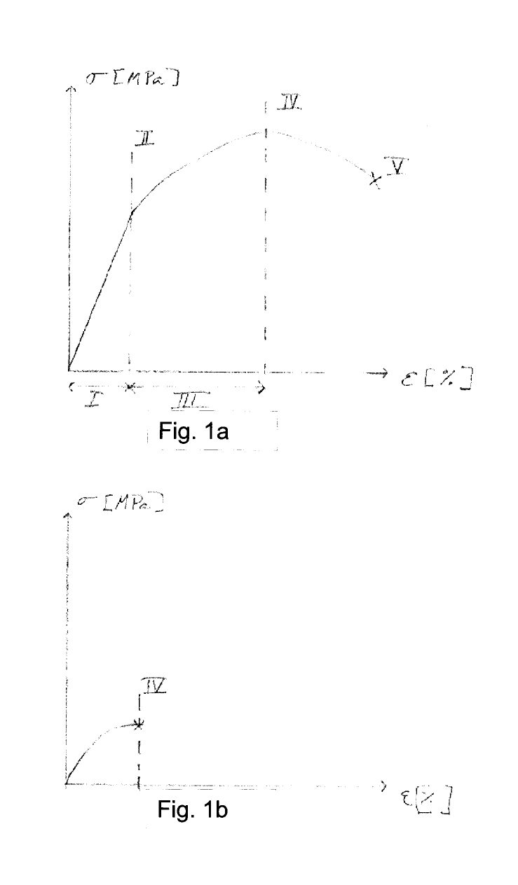

By way of introduction, the theoretical background to the invention will be described briefly with reference to FIGS. 1a and 1b.

The strength of metallic material may for example be represented by stress-strain diagrams based on tensile testing of test bars. FIG. 1a depicts schematically the pattern of the stress-strain diagram for many metallic engineering materials, e.g. steel. FIG. 1b illustrates the pattern of the stress-strain diagram for grey iron.

FIG. 1a depicts generally a first region I in which small forces act upon the test bar. In this region the distance between the atoms in the material increases without affecting their mutual arrangement. If the force is removed, the test bar reverts to its original dimensions. The test bar is thus deformed elastically. This region is usually called the linear elastic region. If a larger force is applied to the test bar, the stress in the material increases. When the stress passes the so-called elastic limit II, the atom planes begin to slide over one another and the material undergoes permanent deformation. If the force is further increased, the material continues to be deformed plastically in the region designated III in FIG. 1a. At a certain stress known as the tensile strength IV, a waist begins to form in the test bar. If still further force is applied to the test bar, it will eventually give way, at V in FIG. 1a.

FIG. 1b illustrates schematically a stress-strain diagram for a cast iron of the grey iron type, using the same designations as in FIG. 1a. The pattern of the stress-strain diagram for grey iron differs from the general stress-strain diagram in FIG. 1a in that grey iron has no linear elastic region at the beginning of the stress-strain curve. Moreover, the elongation of grey iron before fracture, which is about 1%, is significantly less than the elongation of, for example, steel, which is typically 20%. FIG. 1b shows grey iron beginning to deform plastically as soon as any load is applied. The reason for this deformation behaviour is supposed to be that graphite flakes in grey iron serve as stress concentrations. The grey iron's perlitic matrix becomes plastic locally round the tips of the graphite flakes, and increasing load results in the formation of cracks between the flakes. Unlike for example steel, grey iron thus has no region of linear elastic behaviour. Further loading of the grey iron test bar causes the material to pass its tensile strength IV at which the test bar gives way.

As grey iron becomes deformed plastically even at small loads, several strength parameters can be calculated from the lower part of its tensile curve. This is because both the initial slope of the curve and the amount of plastic deformation are closely related to the graphite structure and the nature of the matrix of grey iron.

As mentioned in the introduction, tensile tests are often carried out on test bars cast jointly with grey iron components in order to assure the quality of cast components. In the known methods, the tensile strength of the test bar is determined by a tensile test. This tensile strength and predetermined relationships between measured tensile strengths of test bars and measured fatigue strengths of cast components then serve as a basis for estimating the fatigue strength of the component.

However, it has been found that the expected fatigue strength of the actual grey iron component does not always correspond satisfactorily to the predicted fatigue strength based on the tensile strength of the test bar.

A study showed that grey iron test bars made in the same way and of the same type of grey iron certainly exhibit substantially the same tensile strength but that the patterns of their stress-strain curves may differ. The reason for this is thought to be, for example, variations in the composition of the grey iron or in the process of making the test bars, e.g. the nucleation potential of the parent iron, type of inoculant or method of inoculation.

A further study showed that not only the tensile strength but also various strength parameters derivable from the stress-strain curve are important in predicting fatigue strengths of cast grey iron components. The pattern of the stress-strain curve greatly affects the magnitude of these parameters, so variations in the pattern of the curve greatly affect how accurately the fatigue strength of components can be predicted on the basis of the strength parameters.

An experiment at the time of the aforesaid studies showed that a very good match between estimated and actual fatigue strength of a finished grey iron component is achieved if the estimation of the fatigue strength is based on strength parameters determined in the initial part of the tensile test curve, i.e. in a region where the load upon the grey iron test bar is below its tensile strength. In this region it is for example possible to determine the following strength parameters:

Rt(0.1), i.e. the stress at 0.1% total strain.

E(0), i.e. slope of the stress-strain curve at 0 MPa stress.

E(50), i.e. slope of the stress-strain curve at 50 MPa stress.

E(100), i.e. slope of the stress-strain curve at 100 MPa stress.

As a first step of the experiment, seven series of ten cylinder heads each were made from a commercially available grey iron alloy. The cylinder heads were made by methods intended for batch production.

A test bar with a waste diameter of 8 mm was then taken from each cylinder head. The test bars were subjected to a tensile test in a 100 kN servo-hydraulic tensile machine of MTS make. The test was carried out at room temperature with controlled movement at 0.05 mm/s. The data gathering involved using an extensometer of MTS type 634.11 F-24. The measuring length was 25 mm and the data gathering rate 10 Hz.

The cylinder heads were placed in a test rig and subjected to cyclic fatigue testing until cracks were detectable in them.

The tensile strength Rₘ and the E₁₀₀ were determined for each test bar on the basis of the data gathered.

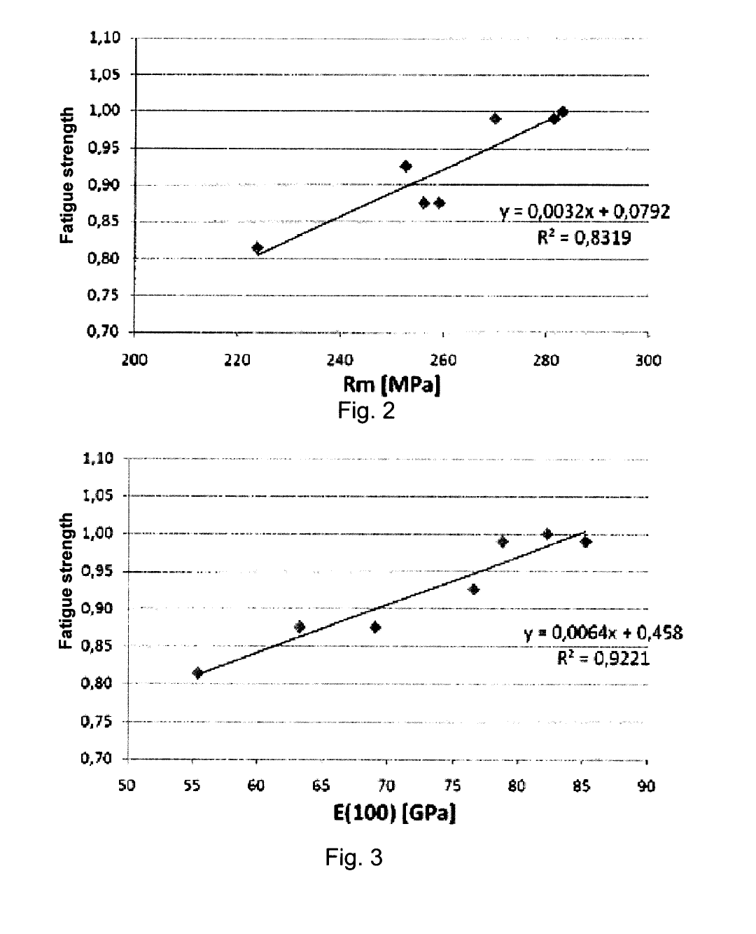

The tensile strength determined was then compared with the fatigue strength measured on each series of cylinder heads. FIG. 2 illustrates the match between the tensile strength and the fatigue strength. A linear relationship was derived between the measured tensile strength Rₘ of the test bars and the fatigue strength of the cylinder heads. The R² value was calculated from this relationship. The R² value, which represents how well the relationship corresponds to reality, may range between 0 and 1, where 1 means that the relationship perfectly matches reality. The R² value for the relationship in FIG. 3 is 0.83.

FIG. 3 plots E₁₀₀ and the fatigue strength for the respective series of cylinder heads/test bars. Here again a linear relationship has been calculated between the E₁₀₀ values and the fatigue strength. The R² value of the relationship is 0.92, representing a very good match between E₁₀₀ and the fatigue strength arrived at by means of the relationship. FIG. 3 thus shows that a better match between actual and predicted fatigue strength is achieved when the predicted values are based on strength parameters which are below the tensile strength than when they are based solely on the tensile strength.

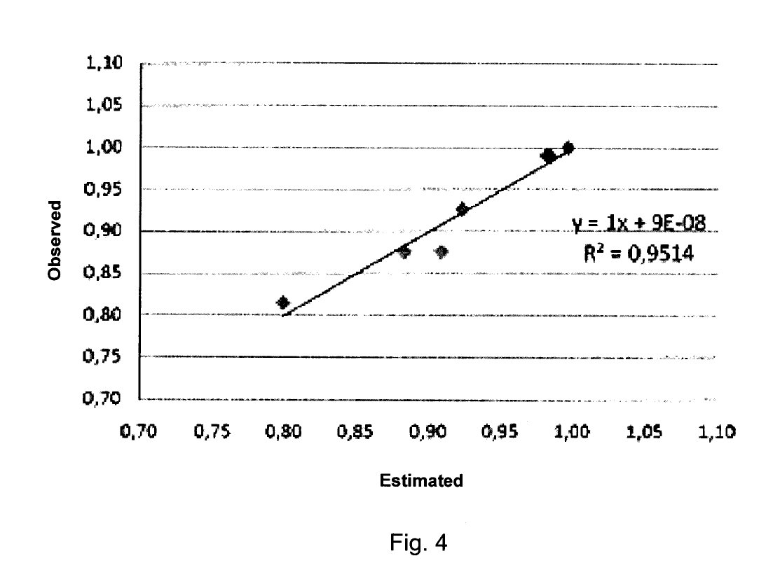

FIG. 4 plots the measured fatigue strength against the predicted fatigue strength. The predicted fatigue strength was determined on the basis of both E₁₀₀ and the tensile strength according to the following relationship: predicted fatigue strength=0.2129+3.473·10⁻³·E(100)+1.759.10⁻³·R,

The line drawn in FIG. 4 shows a good match between measured and predicted fatigue strength.

As the R² value of 0.95 shows, the match is better if more strength parameters are added to the relationship.

Similar to the above studies, the invention is based on the possibility of deriving appropriate magnitudes from a curve which represents the ratio between a small load applied directly to an engine component and measured deformation of the component's material. These magnitudes may then be used for predicting with great accuracy the fatigue strength of engine components.

The method according to the invention involves first arriving at, i.e. predetermining, a relationship between fatigue strength of engine components and magnitudes which are determined from the ratio between load applied to and resulting deformation of engine component material at small loads.

This is done in the following way: First, several series of engine components are made, e.g. three series of ten components each. Both the number of series and the number of components in each may vary. Each series is made in a separate casting process in order to achieve sufficient variation. Each component, or part of each component, is then subjected to a small load. The load, e.g. a force applied to the component, may be so little that the resulting stresses in the component do not exceed the tensile strength or fatigue limit which the respective component is supposed to be able to cope with. Specialists may relatively easily assess, e.g. on the basis of experience, what loads such a component can withstand.

To ensure that the component will not disintegrate when put under load, it is appropriate to load it to for example, not more than 50% of the tensile strength.

If only part of the component is loaded and will not be subject to loads during operation, greater loads may also be adopted for the test.

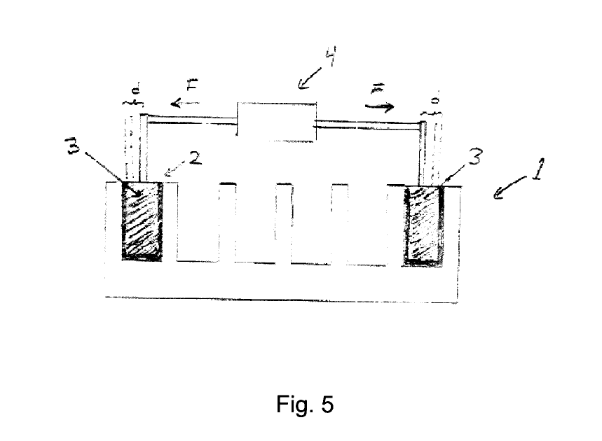

Loading the component and measuring its resulting deformation may be done as described below, see FIG. 5.

FIG. 5 depicts an engine component 1, in this case an engine block which has cavities 2 for cylinders. Two force-transmitting means 3, e.g. two rods, are inserted downwards in the respective cylinder cavities 2. The respective force-transmitting means 3 are connected to a hydraulic device 4 which is adapted to moving them sideways away from one another. A force F is then applied by the hydraulic device 4 to the force-transmitting means, causing them to move sideways along the centreline of the engine block. The movement of the force-transmitting means causes deformation of the component, i.e. the component's material becomes deformed. The forces F are increased successively to a predetermined value, e.g. until the stress in the engine block reaches 15% of its supposed tensile strength. After each increase in the force F, the resulting movement of the force-transmitting means is measured. This movement may for example be measured as the distance d which each force-transmitting means travels from its starting point at the beginning of the loading (represented by broken lines in FIG. 5). The distance d serves as a measure of how much the component has been deformed by the force applied. The force applied and the resulting movement are then plotted and various magnitudes can be calculated from the slope of the graph. An example of an appropriate magnitude is the slope of the force/movement curve at an applied force which generates stresses in the component of up to 50% of the supposed fatigue strength of the engine block.

The actual fatigue strength of each engine component is then determined by cyclic fatigue testing until a predetermined value which represents cracks is passed or the component disintegrates. This may be done by standardised methods.

A relationship is then determined between the fatigue strength of the components and the magnitude determined from the ratio between force applied to and deformation of the component at small loads.

The relationship may for example take the form of a table, an equation or a graph between measured fatigue strength of engine components and the magnitude which is determined from the ratio between measured force applied to and deformation of engine components. The relationship may for example be arrived at from a linear regression applied to the measured values. The relationship is stored, for example, in a non-volatile electronic memory in a computer, from which it is retrievable as necessary.

The accuracy of the relationship between measured fatigue strength of engine components and the magnitude determined from the ratio between measured force applied to and deformation of the engine components may be improved by doing further fatigue tests. It is also possible to further improve the accuracy of the relationship by adding to it observations and experience from actual outcomes in the field.

The relationship arrived at above is then used in the method according to the invention to estimate the fatigue strength of further engine components made for example in ongoing industrial production. This may be done as follows:

As a first step, an engine component is made by casting from grey iron material.

As a second step, at least one magnitude is determined from the ratio between force applied to and deformation at low load of the component or part of it. This magnitude is therefore of the same kind as that on which the predetermined relationship is based. The determination of this magnitude is done, as described above, by the component being subjected to loads below its supposed tensile strength or fatigue limit. During loading of the component, its deformation is measured and a magnitude is determined from the ratio between force applied and deformation.

As a third step, a predetermined relationship arrived at as above is provided.

As a fourth step, the fatigue strength of the component made is estimated on the basis of the magnitude determined from the ratio between force applied to and deformation of the component and the predetermined relationship. This may be done in various different ways.

If the predetermined relationship is a linear curve adjusted to observed fatigue strengths of engine components and measured magnitudes determined from the ratio between force applied to and deformation of engine components, the fatigue strength of the manufactured component can be read from the linear curve.

The relationship may also be taken from a table or non-volatile memory.

In the embodiments described, the engine component may for example take the form of an engine block or a cylinder head for a heavy vehicle, e.g. a truck, but it should be noted that the predetermined relationship has to be based on the same type of component as that whose fatigue strength is to be estimated.

A specific embodiment of the invention is described above in detail. This was for illustrative purposes and with no intention of limiting the invention. It is obvious that various changes and modifications may be made to the invention within the protective scope of the attached claims. For example, a test bar might be cast jointly with the engine component and then be broken off. It might also be taken directly from the manufactured component, e.g. by milling. Tensile tests might then be carried out on the test bar and their results, e.g. the tensile strength, be used in the method according to the invention to predict the component's fatigue strength. For this it is necessary, however, that the predetermined relationship includes measurements from test bars.

1. A method for determining fatigue strength of engine components made of metallic material comprising the steps of
providing an engine component,
loading at least part of the component to a level below its tensile strength and measuring resulting deformation of the component,
determining at least one magnitude on the basis of the load applied and the deformation measured,
providing a predetermined relationship between a measured fatigue strength of the engine component and the at least one magnitude determined on the basis of the ratio between load applied to the component and its deformation, and
determining the fatigue strength of the engine component provided, on the basis of the at least one magnitude determined and the predetermined relationship.

2. The method according to claim 1, in which the engine component comprises a cylinder head or an engine block for a heavy vehicle.

3. The method according to claim 1, further comprising loading the whole engine component.

4. The method according to claim 1, wherein the loading of the engine component to a level below a fatigue limit of the engine component.

5. The method according to claim 1, further comprising: loading the engine component by applying a force provided by a force-transmitting device acting upon the engine component.

6. The method according to claim 5, wherein the force is applied to the component by moving the force-transmitting device relative to the engine component, and the measuring of the deformation of the component comprises measuring the distance which the force-transmitting device moves relative to the engine.

7. The method according to claim 1, further comprising: jointly casting a test bar intended for tensile testing along with the engine component or taking a test bar from the engine component, determining the test bar's tensile strength and using the tensile strength for determining the fatigue strength of the engine component provided.

8. The method according to claim 1, wherein the magnitude is determined at a load before the tensile strength of the component on the fatigue limit of the component.

9. The method according to claim 1, wherein the metallic material is grey iron.
